(19) United States
(12) Patent Application Publication
(10) Pub. No.: US 2026/0179178 A1
(43) Pub. Date: Jun. 25, 2026

(54) Optimal Image Resizing Methods for Machine Learning Applications

(71) Applicant: Advanced Micro Devices, Inc., Santa Clara, CA (US)

(72) Inventors: Rajy Meeyakhan Rawther, San Jose, CA (US); Kiriti Nagesh Gowda, San Jose, CA (US); Lakshmi Kumar, San Jose, CA (US)

(21) Appl. No.: 18/990,814

(22) Filed: Dec. 20, 2024

(51) Int. Cl. G06T 3/4046

(52) U.S. Cl. CPC G06T 3/4046

(57) ABSTRACT

Systems and methods described for choosing optimal resizing images in an image dataset are described. An image or a region of interest (ROI) of the image is chosen and complexity of the image or ROI is computed using one or more methods. Different resizing methods are used for less complex images or ROI, while images with more complex image or ROI are resized differently. The complexity is precomputed for different tiles of images and embedded as metadata within the images. In some cases, the complexity estimates can be calculated dynamically, e.g., when no preprocessed image data is available.

### BACKGROUND

### Description of the Related Art

When choosing a resizing algorithm for images in generating a dataset for machine learning applications, it is desirable to balance quality, speed, and the nature of the task at hand. Nearest-neighbor interpolation is a fast method but may result in blocky, pixelated images, making it suitable for simple tasks where precision is less critical. Bilinear interpolation smooths out transitions by averaging surrounding pixels, producing better-quality resized images with minimal artifacts, making it ideal for general applications. Bicubic interpolation offers even smoother results by considering more neighboring pixels, which can be beneficial for high-quality tasks like image recognition but may be slower. In some cases, particularly in deep learning applications where preserving fine detail matters, more advanced methods such as Lanczos resampling are used, as they maintain high-quality edges and minimize blurring. Ultimately, the choice of resizing algorithm should consider the balance between computational efficiency and the visual integrity of the image, particularly if the resized images will impact model performance or interpretability.

Traditionally, a single algorithm is chosen for resizing all images in a dataset. Using one algorithm across all images ensures uniformity, which is critical for training models that rely on consistent input data. However, the chosen algorithm must strike a balance between preserving important image features and being computationally efficient. Choosing a single algorithm for all the images in the dataset may not provide the best accuracy, performance, and memory consumption. Moreover, choosing different resizing algorithms for different frameworks can cause accuracy differences across frameworks for the same model.

In view of the above, improved systems and methods for choosing optimal resizing mechanisms for images in a dataset are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates components of a system on chip (SOC) device.

FIG. 3 illustrates an image processing system configured to process image data for generating image datasets.

FIG. 4 illustrates a block diagram for creation of an image dataset using image data.

FIG. 5 illustrates a block diagram for creation of an image dataset using video data.

FIG. 6 illustrates a block diagram for dynamic computation of complexity of an image.

FIG. 7 illustrates a machine learning model for processing image data.

FIG. 8 illustrates a method for generating image metadata for unprocessed image data.

FIG. 9 illustrates a method for selecting a resizing method for an image based on image metadata

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems and methods for choosing resizing algorithms for images in an image dataset are described. Implementations described herein describe methods and systems for choosing resizing methods, e.g., to generate scaled (downscaled or upscaled) images based on complexity and scaling-factor of the image or a portion of the image to be resized. In one or more implementations, complexity is quantified as a measure of edge density, pixel intensity variance, entropy, or otherwise. In other implementations, complexity can be based on motion estimation, and the like. Other methods for computing or estimating complexity are possible and are contemplated. In one example, a scaling factor of image to be resized may impact the quality of resize. For instance, if the scaling factor is large, a resizing method with greater precision needs to be selected, such that important content in the image is not distorted or lost. In one such implementation, an image or a region of interest (ROI) of the image is chosen and complexity of the image or ROI is computed using one or more methods. Further, resizing mechanisms like nearest-neighbor or bilinear methods are used for less complex image or ROI, and bicubic or triangular or Lanczos method is used for images with more complex image or ROI. In another implementation, the complexity is pre-computed for different tiles of image and embedded as metadata of the image. The tiles can be of fine or coarse granularity depending on the object location. The complexity measure can be encoded as part of JPEG header or JSON metadata. These and other implementations are described with respect to the text that follows.

The solutions described herein provide several advantages, particularly when dealing with varied image types, resolutions, and quality requirements. One major benefit of choosing different resizing methods is an increase in computational efficiency. By tailoring the resizing method to each image or portions of each image, better performance in machine learning model executions is achieved. These approaches can also aid in efficient resource utilization, as simpler methods can be used for less demanding images, saving computational time and power for more complex images where higher quality is needed.

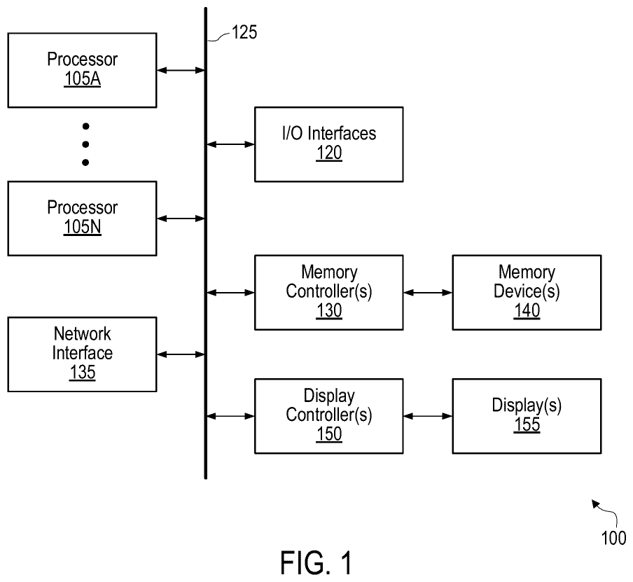

Referring now to FIG. 1, a block diagram of one implementation of a computing system 100 is shown. In an implementation, computing system 100 is configured to, amongst other functionalities, process data, such as but not limited to, unprocessed image data received from one or more imaging devices. For example, the system 100 is configured to identify portions in image data, e.g., regions of interest (or tiles) in a raw image and process these raw image portions to create processed image data. Generally speaking, the following discussion refers to “raw” data which indicates the data us unprocessed or minimally processed. However, the methods and mechanisms described herein are equally applicable to image data that has been more extensively processed (i.e., data that is not considered “raw”). Such alternative implementations are possible and are contemplated. Additionally, the system 100 is configured to process data pertaining to static images and dynamic images (like videos) received from one or more image or video sources, e.g., digital cameras, electronic devices with built-in digital cameras (e.g., mobile devices and laptop computers), security or video surveillance setups, medical imaging systems, and other devices operating in similar contexts.

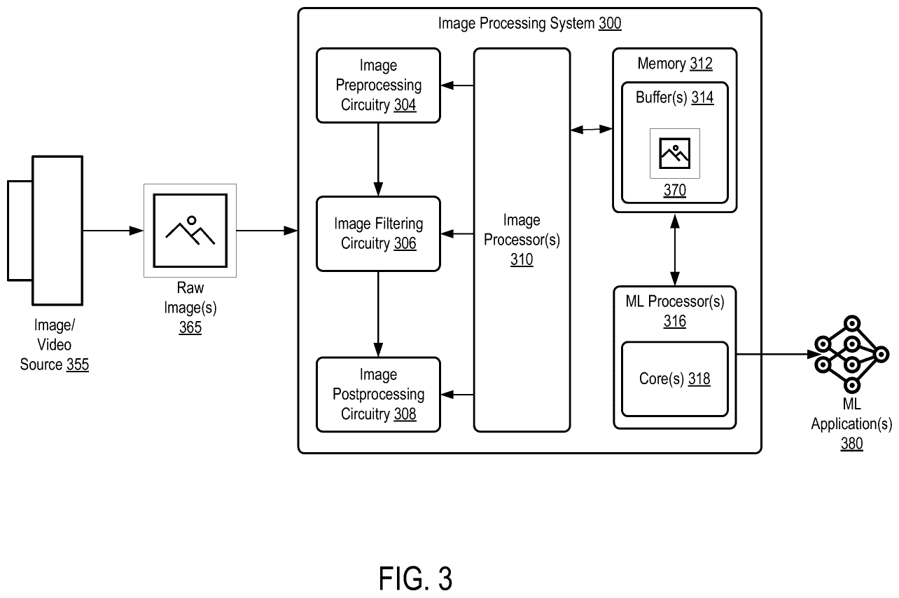

In one or more implementations, the system 100 encompasses a video or image processing system configured to handle imaging data. This can include decompressing, processing, optionally compressing, and transmitting video streams to display device(s) 155. The system 100 processed image and video data retrieved from a variety of sources. The obtained data is usually received in an uncompressed or compressed format. The system 100 decodes the data to prepare the data for one or more functionalities. This involves scaling, color correction, and optimizing the video or image data. In an implementation, the system 100 takes form of an image processing device that processes raw image data (or a portion thereof) for generating image datasets to be used in training of one or more machine learning models (e.g., Deep Neural Network or Convolutional Neural Network models). These and other implementations are explained in detail with respect to subsequent FIGS. 3 to 7. In other implementations, the system 100 is configured to process image data for rendering on one or more display devices. As shown, a display pipeline of a display device(s) 155 receives the processed image data and uses the decoded data to render a video on the display.

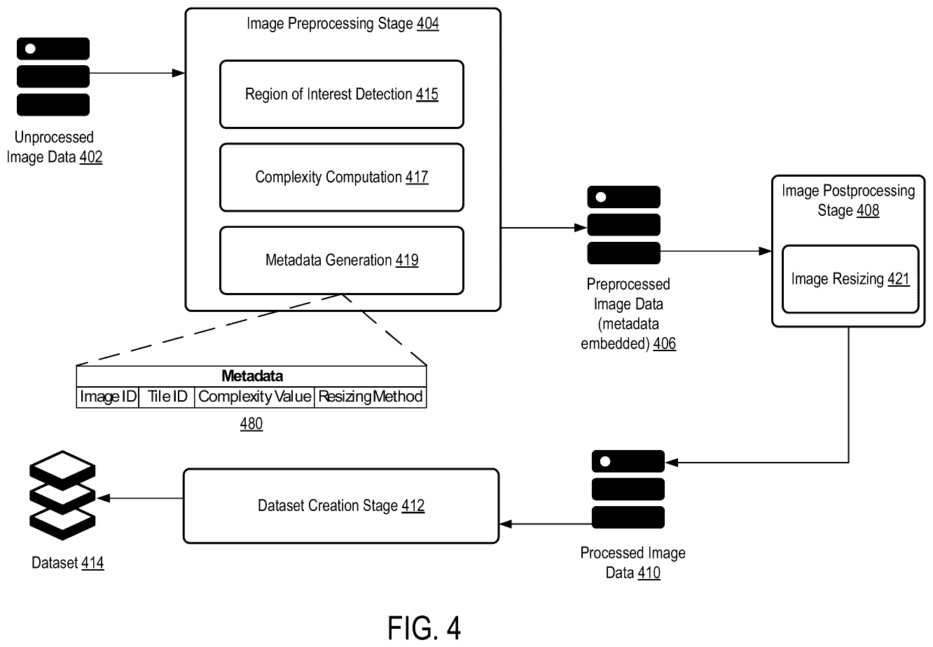

In one implementation, computing system 100 includes at least processors 105A-N, input/output (I/O) interfaces 120, bus 125, memory controller(s) 130, network interface 135, memory device(s) 140, display controller(s) 150, and display(s) 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 4-8 herein.

In one implementation, processor 105A is a general-purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, television, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

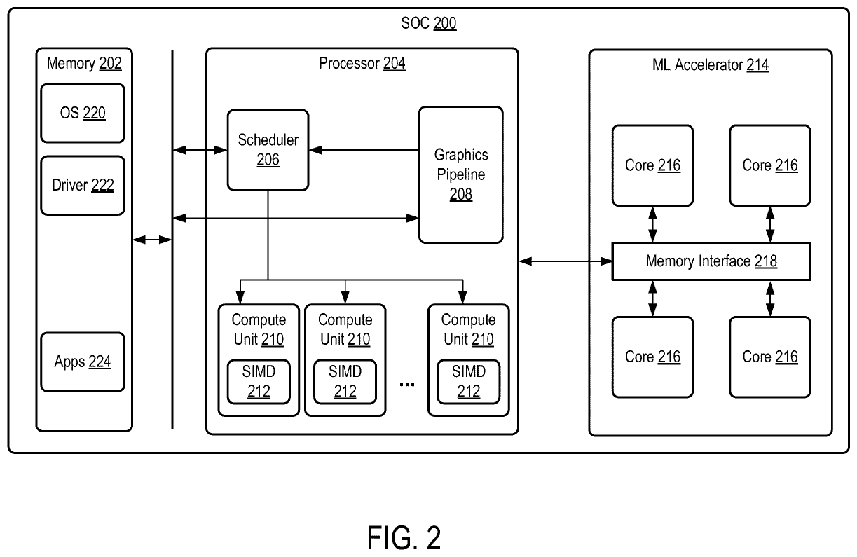

Turning now to FIG. 2, components of a system-on-chip (SOC) device 200 are described. In one or more implementations described, graphics processor 204 executes an operating system 220, a driver 222, and applications 224, and may also execute additional or alternative software. The operating system 220 is programmed to manage various functions of device 200, such as handling hardware resources, processing service requests, scheduling processes, and other tasks. The driver 222 manages the operation of the graphics processor 204, e.g., assigning tasks like graphics rendering or other processing jobs to the graphics processor 204. Additionally, the driver 222 includes a just-in-time compiler that compiles programs for execution by the processing components of the graphics processor 204, such as Singe Instruction Multiple Data (SIMD) units 212, which will be explained further below.

The graphics processor 204 executes commands and programs for specific tasks, including both graphics and non-graphics operations that are suitable for parallel processing. In an implementation, the graphics processor 204 can handle operations in the graphics pipeline 208, such as pixel processing, geometric calculations, and rendering images to a display device (display 155), as requested by a host processor. Additionally, the graphics processor 204 performs compute tasks unrelated to graphics, such as video processing, physics simulations, computational fluid dynamics, and other similar tasks. In certain cases, these compute tasks are executed using compute shaders on the SIMD units 212.

In one example, the graphics processor 204 is an acceleration processing device, e.g., including compute units 210, which house SIMD units 212 designed to perform operations requested by a host processor (or another circuitry) in parallel, following the SIMD paradigm. In this paradigm, multiple processing elements share a single control flow unit and program counter, allowing them to execute the same program simultaneously but with different data. For example, each SIMD unit 212 includes sixteen lanes, wherein each lane runs the same instruction at the same time, but with distinct data. If certain lanes do not need to execute an instruction, they can be disabled using predication. Predication can also be applied to handle programs with divergent control flow. Specifically, for programs with conditional branches or instructions based on calculations performed by individual lanes, predicating lanes corresponding to unused control flow paths and executing different control paths serially enables complex control flow handling.

In an implementation, the compute units 210 are also utilized for performing computation tasks that are unrelated to graphics or not part of the standard operations of the graphics pipeline 208 (e.g., custom tasks that enhance the processing done for the graphics pipeline 208). An application 224 or other software running on a host processor can send programs defining these computation tasks to the graphics processor 204 for execution.

The graphics processing pipeline 208 includes hardware that handles graphics rendering, sometimes utilizing the compute units 210 for tasks such as executing shader programs. Generally, graphics rendering involves transforming 3D geometry into pixels in screen space for display or other purposes. In various examples, the graphics processing pipeline 208 performs operations for one or more shader stages: a vertex shader stage, which runs vertex shader programs on the compute units 212; a hull shader stage, running hull shader programs; a domain shader stage, running domain shader programs; a geometry shader stage, running geometry shader programs; and a pixel shader stage, running pixel shader programs. Additionally, the graphics processor 208 can execute compute shader programs, which are not part of the typical graphics pipeline functionality, using the compute units 212.

In one or more implementations, the SOC 200 further includes a machine learning accelerator (ML accelerator 214). The ML accelerator 214 contains one or more machine learning accelerator cores 216. In some cases, these cores 216 are equipped with specialized circuitry to perform matrix multiplications. Additionally, the ML accelerator 214 includes a memory interface 218, which connects the ML accelerator memory to external components like the graphics processor 204 and memory 202, enabling communication between them. The graphics processor 204 and ML accelerator 214 transmit information with one another, e.g., to carry out machine learning tasks, including both training and inference operations. Inference operations often involve providing inputs to a machine learning network and generating an output, such as a classification or other result. Training operations involve feeding training inputs into the machine learning network and adjusting the network's weights based on a specified training function.

Machine learning networks often include one or more layers, each of which performs operations like matrix multiplication, convolution, step functions, or other processes, and generates an output. In some implementations layers simulate the behavior of artificial neurons, though other types of machine learning models are possible and are contemplated. Such layers process inputs through these one or more artificial neurons, where each neuron applies a weight to the inputs, sums the weighted inputs, and optionally applies an activation function. The weighted sums of the neuron inputs are executed as matrix multiplications within the machine learning accelerator core 216. In another case, a layer may perform convolutions, where a filter is repeatedly applied to pixel values from an image, computing dot products. Since multiple dot products are needed, convolution operations are mapped to matrix multiplications on the cores 216. Although matrix multiplication is the primary function of the cores 216, in some implementations, these cores also perform other operations or additional tasks.

In one or more implementations, for training a deep neural network (DNN) using an image dataset, the machine learning accelerator cores 216 are optimized for tasks such as matrix multiplications, convolutions, and activation functions, which are essential in deep learning for images. The process involves processing image data in batches through layers designed for image analysis, such as convolutional, pooling, and fully connected layers. In the forward pass, convolutional layers extract spatial features by applying filters, which are followed by non-linear activation functions and pooling layers to reduce dimensionality. The flattened features are then passed through fully connected layers to generate predictions. The difference between the prediction and the actual label is calculated using a loss function, and backpropagation adjusts the network's weights based on the computed gradients. The cores 216 handle the matrix multiplications and convolutions in parallel, speeding up both forward and backward passes. This process of forward pass, loss calculation, and weight updates repeats over many epochs, allowing the DNN to learn from the image data and improve its accuracy in recognizing patterns.

In an implementation, creating an image dataset from raw image data involves several processing steps to ensure the data is usable for training of or inference using a machine learning model. In these steps, raw images are collected from various image or video sources and raw data is pre-processed. This includes resizing images to downscale or upscale images for ensuring consistent dimensions, normalizing pixel values, and/or converting images to grayscale or a specific color format depending on the task. In some cases, data augmentation techniques, like flipping, rotating, or cropping, are applied to artificially expand the dataset and improve model generalization. The resultant dataset is split into training, validation, and testing subsets, ensuring a balanced and representative distribution of classes in each set.

Currently, resizing methods like nearest-neighbor, bilinear, bicubic, etc. are chosen randomly to preprocess image data, e.g., based on heuristics for each ML framework. This can negatively affect the convergence and accuracy of the ML model being trained or executed for inference. Moreover, choosing different resizing algorithms for different frameworks can cause accuracy differences across frameworks for the same model. Furthermore, choosing a single resizing method for all the images in the dataset does not give the best accuracy, performance, and memory consumption.

Implementations described herein propose methods and systems for choosing resizing methods, e.g., to generate scaled images (i.e., downscaled or upscaled image data) based on complexity and scaling-factor of the image to be resized. In one such implementation, an image or a portion of an image, such as a region of interest (ROI) of the image, is chosen and complexity of the image or ROI is computed using one or more methods (e.g., Harris Corners detection). Further, resizing methods like nearest-neighbor or bilinear methods are used for less complex image or ROI, and bicubic or triangular or Lanczos method is used for images with more complex image or ROI. In another implementation, the complexity is pre-computed for different portions or tiles of image data, and embedded as metadata within the image data. The portions or tiles of the image can be of fine or coarse granularity depending on the object location. The complexity measure can be encoded as part of JPEG header or JSON metadata. These and other implementations are described with respect to the text that follows.

FIG. 3 illustrates an image processing system 300 configured to process image data for generating image datasets. The system 300 can represent various electronic devices, including smartphones, personal computers, laptops, tablets, video gaming consoles, vehicular information systems, and similar devices. In one implementation, the system 300 includes a SOC (e.g., SOC 200) or a collection of one or more integrated circuit (IC) dies. In one configuration, the system 300 is connected to a video or image source 355, to obtain raw image data 365. In one example, the obtained raw image data 365 is stored in memory 312, which can be dynamic random access memories (DRAMs), static random access memories (SRAMs), or a combination of both.

The system 300 further includes one or more processors 310, such as central processing units (CPUs), graphics processing units (GPUs), or a combination, as well as other hardware components, such as image preprocessing circuitry 304, filtering circuitry 306, and image postprocessing circuitry 308. In one or more implementations, functionalities of these circuitries can also be implemented by the processor(s) 310 running software, hardcoded logic, programmable logic, or a combination of these methods. The system 300 can further include an output interface (not shown), such as a network interface, USB interface, HDMI interface, or similar, that can connect to a display device to output an image for display. As explained further in relation to FIG. 3, in at least one implementation, images processed using circuitries 304-306 are utilized to generate one or more image datasets, e.g., to be used to run training and/or inference for machine learning (ML) application(s) 380.

In one implementation, image preprocessing circuitry 304 includes components designed to prepare raw image data 365 for further processing, e.g., to improve the quality of the data making it suitable for tasks like object detection, recognition, or classification. The circuitry 304 can include Analog-to-Digital Converters (ADC) to convert analog signals from an image sensor into digital data that can be processed by the system 300. The circuitry can further include image sensor interfaces for capturing raw image data 365 from an imaging sensor (e.g., CMOS or CCD). The circuitry 304 can perform white balance adjustment to correct color imbalances due to different lighting conditions, ensuring that whites appear neutral and other colors are rendered accurately. Other functionalities are possible and are contemplated. In one or more implementations, the above described functions of the circuitry 304 can be by other types of components or circuitry such as System on Chip (SoC) components including, but not limiting to, Digital Signal Processors (DSP), GPU, CPU, Neural Processing Units, and the like. Various such implementations are possible and are contemplated.

In one or more implementations, the preprocessed images are transmitted to a filtering circuitry 306, to execute a noise filtering (or “denoising”) process. This process is executed to remove low, medium, or high-frequency noise from the preprocessed images. Further, the filtered or denoised images are then passed to the image postprocessing circuitry 308. Filtering circuitry 306 includes additional components not shown for the sake of brevity. These can include an input interface to receive image data and control logic to manage operations and adjust parameters dynamically. Further, a memory interface supports intermediate data storage, while an output interface enables transmission of filtered data. Integrated power management can be used for energy efficiency, and a high-speed communication bus to connects the components. The circuitry 306 is designed for adaptable and efficient noise reduction across various imaging applications.

At this stage, the postprocessing circuitry 308 performs additional postprocessing tasks, such as converting image formats or color spaces (e.g., from YUV to RGB), upscaling, downscaling, or cropping. Some components of the postprocessing circuitry are not shown for the sake of brevity. These can include an input interface configured to receive denoised image data such that one or more image data processor(s) can perform color correction, edge enhancement, resolution adjustment, etc. on such data. The circuitry 308 can further includes a memory interface for intermediate data storage and retrieval and an output interface having compatibility with multiple image formats, such as JPEG or PNG. Additional components of the postprocessing circuitry 308 include control logic and power management unit(s) Further, high-speed communication bus interconnects all components, ensuring synchronized data flow. In one implementation, a configurable processing pipeline, e.g., implemented via FPGA or ASIC, supports user-defined processing tasks, enabling customization for specific applications.

In one implementation, the processed images are used to generate an image dataset for use in one or more machine learning applications 380. As shown, an image dataset 370 is generated and stored in a buffer 314 within the memory 312. In such implementations, ML processor(s) 316 can execute training or inference operations using ML cores 318 (e.g., as explained with respect to FIG. 2). Traditionally, to train or infer a ML model that deals with image based dataset, at least some of the dataset needs to be modified, such that images of various sizes and color-formats are cropped and resized into a consistent dimension as required by the model. Currently resizing algorithms like nearest-neighbor, bilinear, bicubic etc. are chosen randomly based on heuristics for each ML model framework and therefore can negatively affect the convergence and accuracy of the model. Moreover, choosing different resizing algorithms for different frameworks can cause accuracy differences across frameworks for the same model. To this end, the system 300 is configured to select a resizing method for rescaling or resizing each image (e.g., to generate a downscaled or upscaled image), based on estimated complexity computed for each image. That is, a standardized method is opted to choose resizing algorithms based on the complexity of an image or a region of interest (ROI) of an image.

In operation, the circuitry 304 is first configured to identify region(s) of image in each image. In one example, the ROI is identified based on the content of an image. In this implementation, the circuitry 304 is configured to preprocess the image and perform edge detection to identify boundaries of objects in the image. In one implementation, the circuitry 304 is configured to perform edge detection method(s) such as Canny Edge detection, Harris Corner Detection, or otherwise, for detecting edges in the image. Further, feature extraction algorithms, like Scale-Invariant Feature Transform (SIFT), Speeded-Up Robust Features (SURF), or Histogram of Oriented Gradients (HOG), can be used to identify key points and patterns within the image that could correspond to the region of interest. In other implementations, ROI can further be detected by leveraging machine learning models, such as, convolutional neural networks (CNNs), or object detection frameworks like YOLO (You Only Look Once), R-CNN (Region-based CNN), or SSD (Single Shot Detector) to identify specific regions in an image.

For each identified ROI of the image (or in some cases the entire image), the circuitry 304 is further configured to compute an estimate of complexity. In one implementation, the circuitry 304 is configured to compute the estimate of complexity by estimating a number of detected corners or interest points. For instance, an image with more corners may contain a higher level of detail, such as multiple edges, textures, or objects. Conversely, a simple image with fewer distinct features will have fewer detected corners. Further, the presence of strong edge regions can also contribute to the overall complexity of the image. In an implementation, the complexity of the image can be quantified by combining the number of detected corners and the distribution of these points.

In an alternative implementation, the complexity of an ROI or image can further be estimated by encoding an image using fixed quantization. In this implementation, if the ROI or image is less complex (e.g., background), the number of bits required to encode will be significantly less compared to more complex image with objects. The circuitry 304 stores the computed estimate of complexity for each ROI or image, where a higher score reflects a greater number of key features and intricate details in the ROI or image. These estimates are stored in memory 312. In another implementation, computed complexity estimate for each tile of a given image is embedded as metadata for the image. The image can be segregated into tiles of fine or coarse granularity depending on location of objects. Further, the complexity measure can be encoded as part of JPEG header or JSON metadata for each image. Other implementations are possible and are contemplated.

In one or more implementations, pre-computed thresholds for complexity are also stored in the memory 312. These thresholds can be generated for various applications and use-cases. In one example, threshold complexity estimate values are hardcoded and stored to identify a complexity level, e.g., low complexity, medium complexity, and high complexity.

In an implementation, the computed estimates of complexity for images or regions of interest are used for rescaling images, e.g., when the image dataset 370 is initially generated. In one or more implementations, when using the image dataset 370, the ML processor(s) 316 utilize the complexity estimate to resize the image based on a particular use case. For example, while running inference for a ML model, the ML processor(s) 316 extracts the value of complexity estimate for each image or ROI, and applies a resize algorithm based on this value. In one non-limiting example, a Nearest Neighbor method is used for images having a complexity estimate value equal to or below a predetermined threshold value for low complexity images. Similarly, a Bilinear or Bicubic Interpolation method for resizing is used for images having a complexity estimate value equal to or below a predetermined threshold value for medium complexity images, but higher than the threshold value for low complexity images. Furthermore, methods like Bicubic Area interpolation are used for resizing images having a complexity estimate value higher than the threshold value for medium complexity images. Other methods of resizing can be similarly selected based on complexity estimate values for each image or ROI.

In an implementation, nearest neighbor method works by selecting a nearest pixel from an image and replicating its color to create new pixels. It is a relatively simple and fast method of resizing, but can lead to misrepresented pixels in a downsampled image and cause aliasing artifacts when the scaling factor is large. Bilinear interpolation works by selecting a weighted average of the of a rectangular grid of a nearest 4 neighbors (2×2) to create the new pixel. This method may give smoother results than the nearest neighbor, but suffers from blurring and loss of details. Bicubic interpolation works by selecting 16 (4×4 rectangular grid) neighboring pixels instead of 4 like done for bilinear method. This method has fewer artifacts than the other methods, however, the method itself can be slower to execute. Lanczos method uses a “windowed sinc” function to create the new pixel. It preserves more details and is a slower slowest algorithm. That is, the Lanczos method is a filtering method which uses a “sinc” function to filter resized pixel values instead of linearly interpolating like the bilinear method.

In some implementations, the values of complexity estimates can also be dynamically computed. For instance, in cases where raw image data 365 and/or image dataset 370 is not available or otherwise not accessible, the system 300 is configured to compute complexity of each image, as the image is being read and decoded. The resizing method is also chosen in real-time based on the computed complexity. In one implementation, the complexity estimates can also be computed dynamically when images are extracted as video frames from a video feed or other video data. These and other implementations are further detailed with respect to FIG. 4-6.

FIG. 4 is a block diagram illustrating creation of an image dataset using raw image data. In one or more implementations, raw or unprocessed image data 402 from one or more image sources undergoes various preprocessing and post processing steps, such that an image dataset is created for use in various applications. In such processing, at least some of the images need to be resized or rescaled based on particular use cases. For instance, for images to be used to train or infer using a ML model, images of various sizes and color-formats need to be cropped and resized into a consistent dimension as required by the model.

During operation, unprocessed data 402 firstly undergoes an image preprocessing stage 404. The image preprocessing state 404 at least includes a region of interest (ROI) detection step 415, a complexity computation step 417, and a metadata generation step 419. Other preprocessing steps, e.g., those described with respect to FIG. 3, are omitted from the discussion for the sake of brevity. In the first step, i.e., ROI detection 415, an image processing system (e.g., system 300) detects ROI in a given image based on the content of the image. As described earlier, in one implementation, an edge detection process is executed to identify boundaries of objects in a given image. In this implementation, the system is configured to perform edge detection method(s) such as Harris Edge Detection operation for detecting edges in the image. Further, feature extraction algorithms can further be used to identify key points and patterns within the image that could correspond to the ROI. In some examples, ROI can also be detected by leveraging machine learning models, such as, convolutional neural networks (CNNs), or object detection frameworks like YOLO (You Only Look Once), R-CNN (Region-based CNN), or SSD (Single Shot Detector) to identify specific regions in an image.

The system is configured to then perform a complexity computation step 417. In this process, an estimate of complexity for each ROI in an image or for the complete image is computed. In an implementation, the complexity computation 417 is done using the numbers of edges or corners detected, e.g., using the Harris Corner Detection method. In this implementation, image or ROI with more corners may contain a higher level of detail, such as multiple edges, textures, or objects. Conversely, a simple image with fewer distinct features will have fewer detected corners. Further, the presence of strong edge regions can also contribute to the overall complexity of the image. In an implementation, the complexity of the image is quantified by combining the number of detected corners and the distribution of these points.

In another implementation, the complexity of an ROI or image can further be estimated by encoding an image using fixed quantization. In this implementation, if the ROI or image is less complex (e.g., image only comprising of a background), the number of bits required to encode will be significantly less compared to more complex image with objects. The system stores the computed estimate of complexity for each ROI or image, where a higher score reflects a greater number of key features and intricate details in the ROI or image.

In the next step, metadata generation 419 is performed. In this process, the computed complexity estimate for each tile of a given image is embedded as metadata for the image. The image can be segregated into tiles of fine or coarse granularity depending on location of objects. Further, the complexity measure can be encoded as part of JPEG header or JSON metadata for each image. Other implementations are possible and are contemplated. In one implementation, the metadata is generated in the form of a table 480, with various fields added to represent data for a given image. As shown, the table 480 includes an image ID field, a tile ID field, a complexity value field, and a resizing method field. Other fields are possible and are contemplated. The preprocessed image data 406, along with metadata embedded for each image or ROI is stored and is passed on to an image postprocessing state 408.

In the image postprocessing stage 408 at least an image resizing step 421 is performed. Other postprocessing steps, e.g., those described with respect to FIG. 3, are omitted from the discussion for the sake of brevity. In an implementation, the image resizing step 421 (e.g., resizing image to generate an upscaled or downscaled image) is performed to further process the preprocessed image data 406, such that images of various sizes and color-formats are cropped and resized into a consistent dimension as required by one or more applications. These applications can include machine learning applications, such as training a ML model and/or running inference using a ML model. Other applications are possible and are contemplated. For example, for training or inference processes, input images are needed to be resized in the dataset to the size required by the model being trained (or inferred). For instance, training of the model may happen on lower resolutions like 224×224 or 229×229 depending in the model size.

In one or more implementations, different resizing methods are used to perform the image resizing 421 for individual images. For example, these methods can include resizing based on nearest-neighbor, bilinear, bicubic methods, etc. In this implementation, the system is configured to extract, from the metadata for each image, an estimate of complexity computed for each image. Based on the computed complexity estimate, an adequate resizing mechanism is selected and executed.

In one non-limiting example, a nearest neighbor mechanism can be used for images having a complexity estimate value equal to or below a predetermined threshold value for low complexity images. In another example, a bilinear or bicubic interpolation method for resizing is used for images having a complexity estimate value equal to or below a predetermined threshold value for medium complexity images, but higher than the threshold value for low complexity images. Furthermore, methods like bicubic area interpolation are used for resizing images having a complexity estimate value higher than the threshold value for medium complexity images. Other methods of resizing can be similarly selected based on complexity estimate values for each image or ROI.

It is noted that even though the image resizing 421 is shown as part of an image postprocessing stage, in various other implementations, the image resizing 421 can also be performed at the image preprocessing stage 404 or dataset creation stage 412. Further, resized or rescaled images form the processed image data 410, which can be used in one or more applications. In the current example, the processed image data 410 is used in the dataset creation stage 412, e.g., to generate an image dataset 414. In this example, the image dataset 414 can be used as a training dataset for a ML model, e.g., image classification models, object detection models, or other generative models. Other implementations are possible and are contemplated.

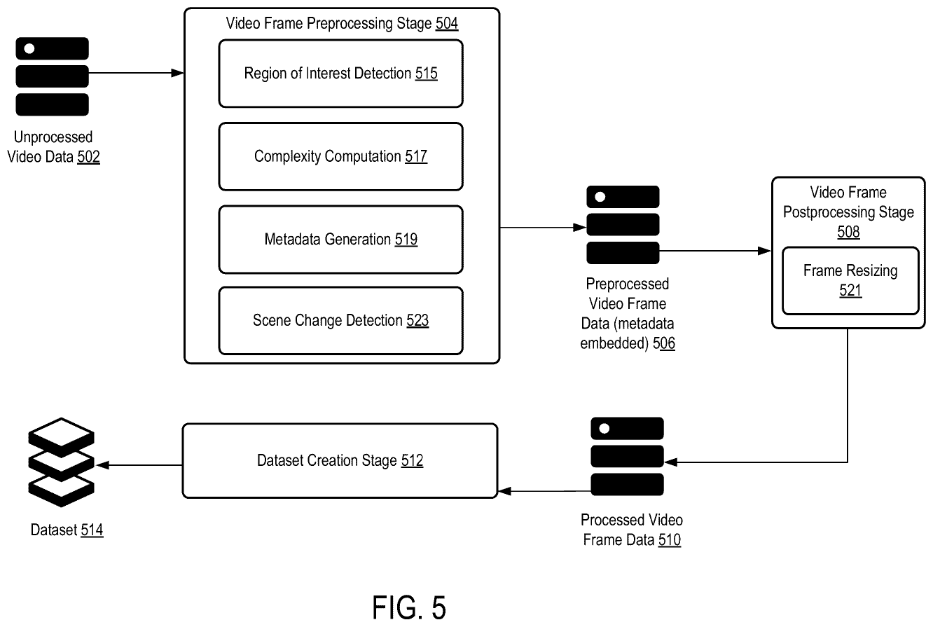

FIG. 5 is a block diagram illustrating creation of an image dataset using raw video data. In an implementation, unprocessed or raw video data 502 is obtained by a video or image processing system, e.g., through one or more video data sources. These can include, without limitation, video from video devices, public video datasets, camera feeds, and the like. This data 502 is first passed to a video preprocessing stage. In the shown example, the video preprocessing stage at least includes ROI detection 515, complexity computation 517, metadata generation 519, and scene change detection 523. Other preprocessing steps for video data have been omitted for the sake of brevity.

In an implementation, the system performs the ROI detection 515 for individual video frames identified in the unprocessed video data 502. In an example, steps 515-519 may not be repeated for each video frame, because of spatial proximity between consecutive video frames. In such cases, ROI detection 515 and complexity computation 517 are only performed for video frames in batches. Preprocessing video frames in batches can save computational resources, reduce redundancy, and speed up tasks like video compression, object detection, or scene recognition. In one implementation, each time a scene change is detected (by continuously executing a scene change detection 523 operation in parallel to other preprocessing steps), the ROI detection 515 and complexity computation 517 steps are performed. In another implementation, changes in video frame content can also be detected using identification of intra-coded frames (I-frames) in the unprocessed video data 502. The system is configured to perform the ROI detection 515 and complexity computation 517 for each video frame containing unique content.

In an implementation, the ROI detection 515 in video frames can be done by annotated bounding boxes received in unprocessed video data 502. In another implementation, certain mechanisms can automatically define ROI based on criteria such as object detection, face detection, or movement in a scene. For example, in a video where a car is moving, the ROI might be dynamically adjusted to include the car's bounding box in each frame. Further, in some applications, the ROI might change from frame to frame. For example, in object tracking, the position and size of the object in the video frame may change dynamically. In such cases, mechanisms like KCF (Kernelized Correlation Filter), CSRT, or Mean Shift can be used to track the ROI across frames.

Based on the ROI detection 515, complexity is computed for each frame. In one or more implementations, complexity computation 517 is performed using methods such as intra-frame complexity. In this method, the complexity is quantified as a measure of edge density, pixel intensity variance, entropy, or otherwise. In another implementation, complexity computation 517 is performed using inter-frame complexity, motion estimation, and the like. Other methods for computing or estimating complexity are possible and are contemplated. As described in the foregoing, complexity computation 517 is performed each time a scene change detection 523 occurs and/or for each I-frame.

The computed complexities are added as metadata for video frames during the preprocessing stage 504. As shown, metadata generation 519 is performed such that video frame metadata is infused with detected ROI and their corresponding complexity estimate values, for each video frame (e.g., similar to table 480 described in FIG. 4). This metadata is added to the preprocessed video frame data 506. The preprocessed video frame data 506 is then passed to a postprocessing stage 508. In the postprocessing stage 508, at least a video frame resizing step 521 is performed (e.g., to rescale the frame to generate upscaled or downscaled video frame). Other postprocessing steps, e.g., those described with respect to FIG. 3, are omitted from the discussion for the sake of brevity. In an implementation, the resizing step 521 is performed to further process the preprocessed data 506, such that frames of various resolutions are cropped and resized into a consistent dimension as required by one or more applications. These applications can include machine learning applications, such as training a ML model and/or running inference using a ML model. Other applications are possible and are contemplated.

In one or more implementations, different resizing methods are used to perform the frame resizing 521 for individual video frames. For example, these methods can include resizing based on nearest-neighbor, bilinear, bicubic methods, etc. In this implementation, the system is configured to extract, from the metadata for each image, an estimate of complexity computed for each image. Based on the computed complexity estimate, an adequate resizing mechanism is selected and executed. As described in the foregoing, methods like bilinear method, bicubic method, Lanczos method, etc. are selected, wherein any given method is selected based on a comparison of the complexity estimate for the frame or ROI in the frame to a precomputed threshold value.

It is noted that even though frame resizing 521 is shown as part of an image postprocessing stage 508, in various other implementations, the frame resizing 521 can also be performed at the image preprocessing stage 504 or dataset creation stage 512. Further, resized or rescaled video frames form the processed frame data 510, which can be used in one or more applications. In the current example, the processed image data 510 is used in the dataset creation stage 512, e.g., to generate a video frame dataset 514. In this example, the dataset 514 can be used as a training dataset for a ML model, e.g., image classification models, object detection models, or other generative models. The dataset 514 can also be used to infer from a ML model, e.g., using the dataset 514 as inference dataset or test dataset and generating predictions or outcomes from the model. Other implementations are possible and are contemplated.

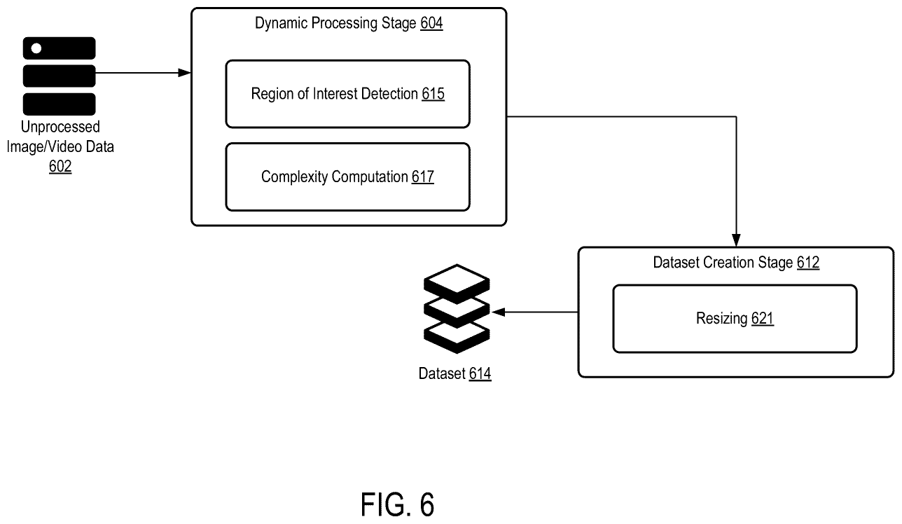

FIG. 6 is a block diagram illustrating dynamic computation of complexity of an image. In one or more implementations, unprocessed video or image data 602 is passed to a dynamic processing stage 604, wherein a ROI detection 615 and complexity computation 617 are performed. In such implementations, ROI detection 615 and complexity computation 617 is performed in real-time, e.g., as the data 602 is being read and decoded. In an example, dynamic processing of data 602 is performed in cases wherein image or video data is not previously available or otherwise inaccessible during the processing stages. In such cases, the data 602 is directly analyzed to detect ROI and compute complexity estimates “on-the-fly.”

Further, based on the computed estimates of complexity, a resizing operation 621 is executed, e.g., at a time a training dataset or inference dataset is generated for a machine learning model. In the shown example, the resizing operating 621 is performed during a dataset creation stage 612. In an implementation, the resizing operation 621 includes a rescaling operation, i.e., generation of upscaled or downscaled images, wherein the rescaling method is dynamically chosen based on the computed estimates of complexity. The resultant dataset 614 is then created for further processing.

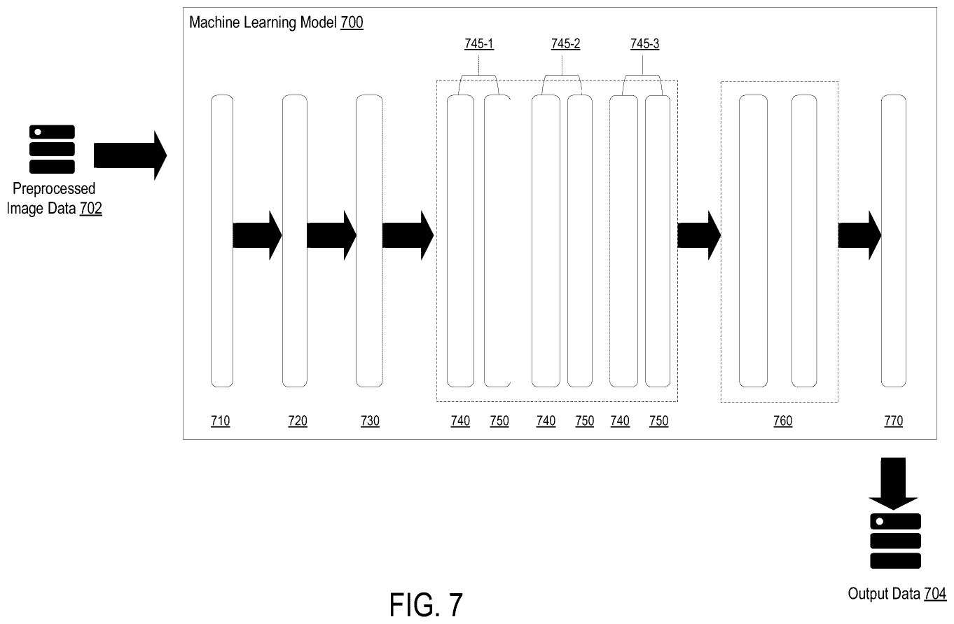

Turning now to FIG. 7, a machine learning model for processing image data is illustrated. In one or more implementations, machine learning model 700 can include Convolutional Neural Networks (CNNs), Transfer Learning Models, Image Classification Models, Generative Adversarial Networks, etc. The example shown in FIG. 7 describes an image classification model, e.g., comprising a sequence of layers executed by specific hardware components to optimize the processing and classification of input image data. In other implementations, however, other types of machine learning models can be similarly processed. Such implementations are contemplated.

The model architecture of the model 700 includes an input layer 710 designed to accept preprocessed image data 702, e.g., containing formatted image inputs of variable dimensions, ensuring flexibility for various image formats and resolutions. As discussed above, preprocessed image data may have been processed to resize the data based at least in part on complexity. In some implementations, the input layer 710 may be designed to perform some resizing operations based on complexity indications. For example, the image data can include metadata that indicates complexity indicators without resizing the data. In such implementations, the input layer 710 may perform resizing operations based at least in part on the complexity indicators. Various such implementations are possible and are contemplated. In one example, the input layer 710 can be processed or otherwise executed by a central processing unit (CPU), which manages initial data handling and pre-processing tasks. A graphics or image processing system (e.g., system 300) can receive raw image data in varying resolutions and formats and perform a sequence of image transformation operations. These operations include normalizing pixel values to a standardized range for optimized model performance, and applying data augmentation techniques such as rotation, flipping, etc. to enhance model generalization and reduce overfitting. The preprocessed image data 702 is subsequently stored in a structured format and fed into the machine learning model 700, facilitating efficient training and inference.

Following the input layer 710, an extraction layer 720 receives the preprocessed image data 702. The extraction layer 720 is a designated layer configured to analyze and process the image data 702 to obtain relevant metadata. In one example, metadata for each image at least comprises a complexity indicator that identifies quantified complexity value of each tile of the image, regions of interest within the image, or the entire image. The extraction layer 720 is comprised of a series of convolutional operations that scan the image, detect features, and generate intermediate outputs. These outputs are also processed to identify and extract other metadata attributes such as object dimensions, color histograms, texture patterns, and spatial relationships. The extracted metadata is formatted into structured data representations for downstream processing or analysis by subsequent layers of the model 700.

In one implementation, the model 700 further includes a resizing layer 730 which is incorporated to adjust all input images to a uniform dimension. In this implementation, the resizing layer 730 uses metadata extracted by the extraction layer 730, such that the complexity indicator is used to select the method which is used to resize each individual image. In one or more non-limiting examples, a nearest neighbor method can be used for images having a complexity estimate value equal to or below a predetermined threshold value for low complexity images. In another example, a bilinear or bicubic interpolation method for resizing is used for images having a complexity estimate value equal to or below a predetermined threshold value for medium complexity images, but higher than the threshold value for low complexity images. Furthermore, methods like bicubic area interpolation are used for resizing images having a complexity estimate value higher than the threshold value for medium complexity images. Other methods of resizing can be similarly selected based on complexity estimate values for each image or ROI. In one or more implementations, in cases wherein the complexity indicators are not available, the model 700 is executed such that a single resizing method is applied to all images. The resizing method can be chosen randomly based on heuristics for each ML framework.

A pseudocode illustrating selection of complexity methods is as shown below:
Low complexity image/ROI (image_complexity<=LOW): Use Nearest neighbor algorithm (e.g., for backgrounds);
Medium complexity image/ROI (image_complexity>LOW AND image_complexity<=MEDIUM): Use Bilinear or Bicubic Interpolation; and
High complexity image/ROI (image_complexity>MEDIUM): Use Bicubic Area interpolation.

The resizing layer 730 is executed to standardize the input size for consistent downstream processing. In an implementation, the resizing layer 730 can be executed by either the CPU for general pre-processing or optimized graphics processing units (GPUs) that can parallelize image transformation operations for faster throughput. The model 700 then progresses to a series of convolutional layers 740 that are responsible for feature extraction. These layers 740, e.g., beginning with a 32-filter convolutional block 745-1 with a 3×3 kernel, can be executed predominantly by GPUs for handling parallel computations inherent in convolution operations. The GPUs can execute the layers 740 for rapid processing of matrix multiplications and the application of other processing or functions (e.g., a rectified linear unit (ReLU) activation function). Each convolutional layer 740 is followed by a max pooling layer 750 to reduce dimensionality, wherein the max pooling layers 750 are also executed by GPUs for optimal performance in downsampling large matrices. Further into the model 700, a second convolutional block 745-2 with 64 filters and a third block 745-3 with 128 filters apply similar operations. In other implementations, the model 700 can have a different number of convolution blocks.

In an implementation, the model 700 further includes other layers 760 that perform one or more functions. For instance, the other layers 760 can include a flattening layer, which transforms multi-dimensional feature maps into a one-dimensional feature vector. This layer can be executed by the CPU or GPU depending on the model size and required processing speed. The layers 760 can further include a dense (fully connected) layer, e.g., consisting of 128 neurons, and subsequent dropout layer. This layer can additionally leverage tensor processing units (TPUs), which are specialized for deep learning tasks and optimize the training of large neural networks by accelerating matrix multiplications and activation functions.

The final layer executed for the model 700 is the output layer 770, which generates classification predictions, e.g., from images included in the preprocessed image data 702. The output layer 770, in one example, includes a predetermined number of neurons and is configured to apply functions, such as a SoftMax activation function, to output a probability distribution across classification categories. In one implementation, the output layer 770 is executed by GPUs or TPUs. The output data 704 generated as a result of execution of the model 700 can serve as a critical component for various applications, providing valuable insights and decisions based on the analyzed image input. The output data 704 includes a set of class probabilities or categorical predictions that indicate the likelihood of an input image belonging to predefined categories. The output data 704 can be used in real-time decision-making processes, such as automated quality control in manufacturing, medical image analysis for early diagnosis, or security systems for face recognition and anomaly detection.

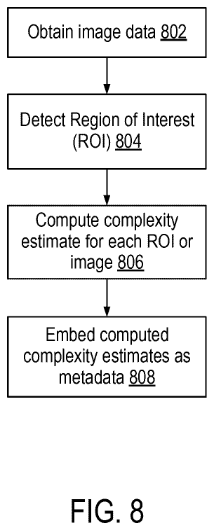

FIG. 8 is a method for generating image metadata for unprocessed image data. According to one implementation, an image processing system (e.g., processing circuitry 300 described in FIG. 3) that includes processing circuitry that is configured to pre-compute estimates of complexity for an image or regions of interest within the image. The processing circuitry computes these estimates for different tiles of the image and embeds the values of complexity estimates as metadata. In one or more implementations, the tiles can be selected using fine or coarse granularity, e.g., depending on locations of particular objects in the image. Further, the complexity estimate values can be encoded as part of JPEG header or JSON metadata.

As shown in the figure, the processing circuitry firstly obtains unprocessed image (or video frame) data from one or more image sources (block 802). In an implementation, raw or unprocessed data pertaining to images is received from one or more image or video sources, e.g., digital cameras, electronic devices with built-in digital cameras (e.g., mobile devices and laptop computers), security or video surveillance setups, imaging systems, and other devices operating in similar contexts.

At a preprocessing stage, the processing circuitry is further configured to determine region of interest (ROI) in a given image (block 804). In one implementation, the ROI is identified based on the content of an image. In one example, the processing circuitry is configured to perform edge detection method(s) such as Harris Corner Detection operation for detecting edges in the image to identify ROI within an image, e.g., based on number of edges or corners detected in the image. Further, feature extraction algorithms, like Scale-Invariant Feature Transform (SIFT), Speeded-Up Robust Features (SURF), or Histogram of Oriented Gradients (HOG), can be used to identify key points and patterns within the image that could correspond to the ROI.

The processing circuitry then computes a complexity for each identified ROI, image tile, or, for the entire image (block 806). In one example, the complexity estimates are computed by estimating a number of detected corners or interest points in a ROI or image. For instance, an image or ROI with more corners may contain a higher level of detail, such as multiple edges, textures, or objects. Conversely, a simple image with fewer distinct features will have fewer detected corners. Further, the presence of strong edge regions can also contribute to the overall complexity of the image. In an implementation, the complexity of the image can be quantified by combining the number of detected corners and the distribution of these points.

In an alternative implementation, the complexity of an ROI or image can further be estimated by encoding an image using fixed quantization. In this implementation, if the ROI or image is less complex (e.g., background), the number of bits required to encode will be significantly less compared to more complex image with objects. In one implementation, the computed complexity estimates for each tile of a given image are embedded as metadata for the image (block 808). In such implementations, the image can be segregated into tiles of fine or coarse granularity depending on location of objects. Further, the complexity measure can be encoded as part of JPEG header or JSON metadata for each image. Other implementations are possible and are contemplated.

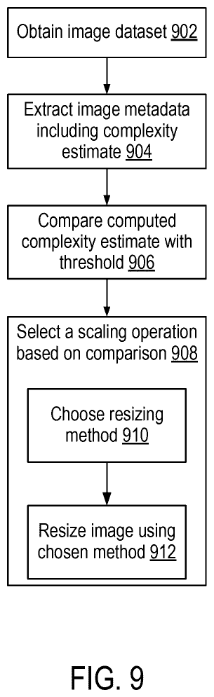

FIG. 9 is a method of selecting a resizing method for an image based on image metadata. As described above, complexity estimates for each tile or ROI in a given image is embedded as metadata for that image. A processing circuitry (e.g., ML processor 316) can extract the metadata from a given image, and use the complexity estimate for the image to rescale the image for use in one or more machine learning applications.

In operation, the processing circuitry obtains an image dataset for executing one or more operations for an ML application (block 902). In this example, the ML application can include a deep neural network (DNN) and the one or more operations can include a training process or inference process corresponding to the DNN. The processing circuitry is configured to extract the metadata from a given image at least including extraction of a complexity estimate corresponding to the image (block 904). The processing circuitry compares the complexity estimate of the image with preset thresholds (block 906).

In an implementation, the computed estimate of complexity for the image or ROI is used by the processing circuitry to select a scaling operation for the image (block 908). For example, the processing circuitry can utilize the complexity estimate to resize the image based on a particular use case. In this example, the processing circuitry extracts the value of complexity estimate for each image or ROI, and selects a resize method based on this value (block 910). In one example, a first resizing method is selected when the image complexity estimate value is equal to or below a predetermined threshold value for low complexity images. Further, a second method for resizing is used when the image complexity estimate value is equal to or below a predetermined threshold value for medium complexity images, but higher than the threshold value for low complexity images. Furthermore, a different method for resizing can be used for resizing the image when the complexity estimate value is higher than the threshold value for medium complexity images. Based on the selected resizing method, the image is resized (block 912). The resized image can further undergo processing, e.g., to be used in one or more applications, such as training an ML model, rendering the display on a display device, etc.

Implementations described herein describe an efficient method to implement for processing image data, without the need of adding additional overhead to the inference or training pipeline for ML models. Embedding complexity as metadata can also be used for other preprocessing operations in a graphics pipeline. In one example, for a training pipeline which does a transformation (e.g., a warp affine transform), the complexity measure can be used to perform simple or complex instructions, thereby improving accuracy and reducing overall latency for the model. Further, the complexity estimate can be precomputed for an entire image dataset ahead of time. At run time, a processing circuitry can simply choose the appropriate resizing mechanism based on the complexity. The complexity measurement will therefore not add an additional bottleneck to the preprocessing pipeline. This can further increase throughput of an image processing system as a whole.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is

1. A system comprising:
circuitry configured to:
access image data;
perform a resizing operation on at least a portion of the image data to generate a resized portion, wherein a type of the resizing operation performed is based at least in part on a complexity indicator associated with the image data; and
execute a machine learning model using the resized portion of the image data.

2. The system as claimed in claim 1, wherein the image data includes metadata comprising the complexity indicator.

3. The system as claimed in claim 1, wherein the circuitry is configured to perform the resizing operation at least in part based on a comparison of the complexity indicator with one or more thresholds.

4. The system as claimed in claim 3, wherein performing the resizing operation on at least the portion of the image data comprises:
performing a first type of resizing operation on a first image associated with a first complexity indicator that is less than a first threshold; and
performing a second type of resizing operation on a second image associated with a second complexity indicator that is greater than the first threshold.

5. The system as claimed in claim 4:
wherein performing the first type of resizing operation on the first image generates a first scaled image with dimensions matching input dimensions of the machine learning model; and
wherein performing the second type of resizing operation on the second image generates a second scaled image with dimensions matching the input dimensions of the machine learning model.

6. The system as claimed in claim 3, wherein performing the resizing operation on at least the portion of the image data comprises:
performing a first type of resizing operation on a first portion of a first image associated with a first complexity indicator that is less than a first threshold; and
performing a second type of resizing operation on a second portion of the first image associated with a second complexity indicator that is greater than the first threshold.

7. The system as claimed in claim 1, wherein the complexity indicator is generated at least in part based on a number of bits used to encode the portion of the image data.

8. The system as claimed in claim 1, wherein the circuitry is configured to perform the resizing operation prior to executing an inference process for the machine learning model using the resized portion of the image data.

9. The system as claimed in claim 1, wherein the circuitry is configured to perform the resizing operation prior to executing a training process for the machine learning model using the resized portion of the image data.

10. A method comprising:
accessing, by a processing circuitry, image data;
performing, by the processing circuitry, a resizing operation on at least a portion of the image data to generate a resized portion, wherein a type of the resizing operation performed is based at least in part on a complexity indicator associated with the image data; and
training, by the processing circuitry, a machine learning model using the resized portion of the image data.

11. The method as claimed in claim 10, wherein the image data includes metadata at least in part comprising the complexity indicator.

12. The method as claimed in claim 10, wherein the resizing operation at least comprises an operation to generate a scaled image.

13. The method as claimed in claim 10, wherein performing the resizing operation on at least the portion of the image data comprises:
performing a first type of resizing operation on a first image associated with a first complexity indicator that is less than a first threshold; and
performing a second type of resizing operation on a second image associated with a second complexity indicator that is greater than the first threshold.

14. The method as claimed in claim 13:
wherein performing the first type of resizing operation on the first image generates a first scaled image with dimensions matching input dimensions of the machine learning model; and
wherein performing the second type of resizing operation on the second image generates a second scaled image with dimensions matching the input dimensions of the machine learning model.

15. The method as claimed in claim 9, wherein the complexity indicator is generated at least in part based on a number of bits used to encode the portion of the image data.

16. An image processing system comprising:
at least one memory storing a given image;
processing circuitry configured to:
access image data corresponding to the given image;
perform a resizing operation on at least a portion of the image data to generate a resized portion, wherein a type of the resizing operation performed is based at least in part on a complexity indicator associated with the image data; and
provide the resized portion of the image data for processing by a machine learning model.

17. The image processing system as claimed in claim 15, wherein the image data includes metadata at least in part comprising the complexity indicator.

18. The image processing system as claimed in claim 15, wherein the complexity indicator is generated at least in part based on a number of bits used to encode the portion of the image data.

19. The image processing system as claimed in claim 15, wherein the circuitry is configured to perform the resizing operation prior to providing the resized portion of the image for an inference process for the machine learning model.

20. The image processing system as claimed in claim 15, wherein the circuitry is configured to perform the resizing operation prior to providing the resized portion of the image for a training process for the machine learning model.
